(19) United States
(12) Patent Application Publication
(10) Pub. No.: US 2012/0244397 A1
(43) Pub. Date: Sep. 27, 2012

(54) BATTERY ASSEMBLY

(75) Inventors: Broc William TenHouten, Santa Monica, CA (US); Philippe Hart Gow, Santa Monica, CA (US); Zachary Meyer Omohundro, Costa Mesa, CA (US)

(73) Assignee: Coda Automotive, Inc., Los Angeles, CA (US)

(21) Appl. No.: 13/160,620

(22) Filed: Jun. 15, 2011

Related U.S. Application Data
(60) Provisional application No. 61/363,470, filed on Jul. 12, 2010.

(51) Int. Cl. H01M 2/10; H01M 2/00; H01M 2/02

(52) U.S. Cl. 429/61; 429/99

(57) ABSTRACT

Battery assemblies for automobiles include cell trays for holding battery cells within a battery enclosure. In some embodiments, battery assemblies described may incorporate the ability to monitor the temperature of one or more battery cells in the assembly where a thermal sensing strip is positioned between battery cells. In other embodiments, battery assemblies may employ a plurality of tensioned straps that may be used to firmly fix battery cells relative to one another and/or allow a user to carry a number of battery cells together. In further embodiments, battery assemblies may include cell trays that are adjustable in configuration to receive varying arrangements of battery cells. Battery assemblies may include a battery module having an upper cell tray and a lower cell tray where battery cells are disposed in receptacles of the upper and lower cell trays such that the battery cells are spaced from one another allowing for air to flow between battery cells.

### RELATED APPLICATIONS

This application claims priority under 35 U.S.C. §119(e) to U.S. Provisional Patent Application No. 61/363,470, filed Jul. 12, 2010, and entitled “Battery Assembly,” which is incorporated herein by reference in its entirety for all purposes.

### BACKGROUND

1. Field

Aspects herein relate to a battery assembly that includes systems and methods for restraining battery cells for use in electric vehicles.

2. Discussion of Related Art

Electric vehicles are commonly powered by a number of battery cells that are disposed in each vehicle. During use, battery cells for an electric vehicle are typically bundled together as battery modules where walls of each battery cell are in contact with neighbouring battery cells. One reason that a module will commonly include battery cells whose walls are in contact with one another is to minimize the amount of volume that the module occupies. It is volumetrically more space saving for battery cell walls to be in contact, or to be shared. In addition, as ions travel between anodes and cathodes of battery cells, a phenomena called cell swelling may occur. Bundling battery cells closely together provides a compressive effect for the battery cells that serves to mitigate cell swelling, thereby extending cell life. Further, battery cells are commonly bundled together so as to decrease the number of contact terminals required for energy transfer. That is, it is possible to connect cells directly together (e.g., by welding through the walls) when the cells share walls or are in close contact.

### SUMMARY

In one aspect, a battery cell assembly is provided. The assembly can include a tray having individual receptacles for each battery cell. Rather than being bundled together as a module, battery cells can be substantially restrained from movement and kept spaced from one another while situated in receptacles of a cell tray. Spacing may provide for a method of cooling as well as for enhanced protection and stability of the system. Cell trays may have predetermined dimensions that depend on the type of electric vehicle the tray will be disposed in as well as the number of battery cells to be positioned in the tray. A battery assembly may include both an upper tray and a lower tray for restraining motion of the battery cells.

Battery cells for use in electric vehicles are often transported from one location to another. However, transporting battery cells may, at times, be cumbersome due to the number of cells to be transported. Because battery cells for electric vehicles are typically compact, so that damage to the cells is minimized, such cells are often transported in small numbers (e.g., one at a time). Accordingly, systems and methods are presented for securing together and transporting groups of battery cells together.

Battery cells may also be positioned in different arrangements for different electric vehicles. Hence, cell trays that include receptacles for receiving battery cells may have different configurations to suit varying battery cell arrangements. Aspects further relate to cell trays that are adjustable in configuration so as to accommodate varying arrangements of battery cells.

While in use, the temperature of a battery cell and/or a region around the battery cell may fluctuate. If the temperature of the cell reaches a certain maximum limit, the cell may consequently overheat and could be damaged or experience reduced life. Thus, aspects also relate to cooling and temperature monitoring of the battery cells.

In one illustrative embodiment a battery module is provided. The battery module includes a first battery cell sub-assembly and a second battery cell sub-assembly, the first battery cell sub-assembly disposed adjacent to the second battery cell sub-assembly, wherein each of the first and second battery cell sub-assemblies comprises a lower battery cell tray having a plurality of lower receptacles; an upper battery cell tray having a plurality of upper receptacles; a plurality of battery cells that are restrained by the plurality of lower receptacles of the lower cell tray and the plurality of upper receptacles of the upper cell tray, wherein each cell is disposed in a corresponding receptacle and the plurality of battery cells are spaced from one another to allow for air flow between battery cells; and a plurality of straps for securing the plurality of battery cells together in the plurality of lower and upper receptacles.

In another illustrative embodiment, a battery module adapted to monitor temperature is provided. The battery module includes a plurality of battery cells; an upper battery cell tray having a plurality of upper receptacles; a lower battery cell tray having a plurality of lower receptacles, wherein each of the upper and lower receptacles are constructed and arranged to receive a single battery cell, the upper and lower battery cell trays including a plurality of receiving portions; and at least one thermal sensor for sensing a temperature of a region near to at least one cell of the plurality of battery cells, wherein the at least one cell is disposed in at least one receptacle of the plurality of receptacles and the at least one thermal sensor is positioned by a region of the plurality of receiving portions such that the at least one thermal sensor is disposed adjacent to the at least one cell.

In a further illustrative embodiment, a battery module is provided. The battery module includes a lower battery cell tray having a plurality of lower receptacles; an upper battery cell tray having a plurality of upper receptacles; a plurality of battery cells that are restrained by the plurality of lower receptacles of the lower cell tray and the plurality of upper receptacles of the upper cell tray, wherein each cell is disposed in a corresponding receptacle; and a plurality of straps for securing the plurality of battery cells together, wherein the plurality of straps comprises at least one tightly tensioned strap adapted to firmly fix the plurality of battery cells together in the plurality of receptacles.

In yet another illustrative embodiment, an adjustable cell tray is provided. The adjustable cell tray includes a receiving area having one or more receptacles disposed in a first configuration, each receptacle constructed and arranged to receive a single battery cell, the first configuration being adapted to receive a first plurality of battery cells in a first arrangement, wherein the receiving area is user adjustable from the first configuration to a second configuration that is adapted to receive a second plurality of battery cells in a second arrangement that is different from the first arrangement.

In another illustrative embodiment, a battery assembly is provided. The battery assembly includes a first battery module and a second battery cell module, the first battery cell module disposed adjacent to the second battery module, wherein each of the first and second battery cell modules comprises a battery cell tray having a plurality of receptacles; a plurality of battery cells that are restrained by the plurality of receptacles of the battery cell tray, wherein each cell is disposed in a corresponding receptacle and the plurality of battery cells are spaced from one another to allow for air flow between battery cells; and a plurality of straps for securing the plurality of battery cells together in the plurality of receptacles.

In a different illustrative embodiment, a battery module adapted to monitor temperature is provided. The battery module includes a plurality of battery cells; a battery cell tray having a plurality of receptacles, wherein each of the plurality of receptacles are constructed and arranged to receive a single battery cell, the battery cell tray including a plurality of receiving portions; and at least one thermal sensor for sensing a temperature of a region near to at least one cell of the plurality of battery cells, wherein the at least one cell is disposed in at least one receptacle of the plurality of receptacles and the at least one thermal sensor is positioned by a region of the plurality of receiving portions such that the at least one thermal sensor is disposed adjacent to the at least one cell.

In yet another illustrative embodiment, a battery module is provided. The battery module includes a battery cell tray having a plurality of receptacles; a plurality of battery cells that are restrained by the plurality of receptacles of the battery cell tray, wherein each cell is disposed in a corresponding receptacle; and a plurality of straps for securing the plurality of battery cells together, wherein the plurality of straps comprises at least one tightly tensioned strap adapted to firmly fix the plurality of battery cells together in the plurality of receptacles.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1A depicts a perspective view of an embodiment of a battery assembly;

FIG. 1B illustrates another perspective view of the battery assembly of FIG. 1A;

FIG. 1C illustrates a close-up example of a battery assembly;

FIG. 2A shows a perspective view of an embodiment of an upper cell tray;

FIG. 2B depicts a perspective view of an embodiment of a lower cell tray;

FIG. 3 illustrates a perspective view of an embodiment of an upper cell tray and a lower cell tray, and a busbar in contact with the upper cell tray;

FIG. 4 illustrates a schematic of a cell tray;

FIG. 5 shows a schematic of a receptacle of a cell tray;

FIG. 6 shows a perspective view of another embodiment of a cell tray;

FIG. 7 depicts a perspective view of a further embodiment of a battery assembly;

FIG. 8 illustrates an embodiment of a connecting element of a battery assembly;

FIG. 9A depicts a top view of an embodiment of a thermal sensing strip;

FIG. 9B depicts a schematic of an embodiment of a thermal sensing strip held by positioning elements;

FIG. 9C illustrates a schematic of an embodiment of an assembly of thermal sensing strips;

FIG. 10 depicts a schematic of an embodiment of a plurality of tensioned straps wrapping corresponding battery cells;

FIG. 11A illustrates a schematic of an embodiment of a tightly tensioned strap wrapping a plurality of battery cells;

FIG. 11B shows a schematic of an embodiment of a loosely tensioned strap wrapping a plurality of battery cells;

FIG. 12A depicts a schematic of an embodiment of a cell tray that includes a configuration of battery receptacles;

FIG. 12B illustrates a schematic of another embodiment of a cell tray that includes a configuration of battery receptacles;

FIG. 12C shows a schematic of a further embodiment of a cell tray that includes a configuration of battery receptacles;

FIG. 13 depicts an example of battery cell sub-assemblies in a battery assembly;

FIG. 14 shows an example of a plurality of battery cells disposed in a cell tray; and

FIG. 15 illustrates an example of battery cell sub-assemblies in a stacked arrangement.

### DETAILED DESCRIPTION

Battery modules and assemblies thereof restraining battery cells used in electric vehicles (EVs) are discussed herein. Battery modules may include one or more battery cell trays for holding a plurality of battery cells. Battery modules may also include an upper cell tray and a lower cell tray, where both trays can be used to securely position the battery cells in spaced apart relation. In some cases, battery cell trays are in contact with one or more busbars and/or interconnects that electrically connect battery cells and other components of the battery system together. A battery module may include multiple configurations of battery assemblies. In some embodiments, a battery module includes pairs of upper and lower cell trays that are attached to one another so as to bundle more battery cells according to desired configurations.

In one aspect, a battery cell tray has a receiving area with regions that are adapted to receive battery cells. Such regions may include receptacles where each receptacle has space to accommodate placement of a battery cell. In an embodiment, where an upper tray and a lower tray are provided in a battery module, each tray may contain features that substantially restrain translational and rotational motion of individual battery cells upon placement in the tray. In one embodiment, battery cells that are housed in receptacles of an upper tray are restrained in a first direction perpendicular to the plane of the upper tray as well as directions within the plane of the upper tray. Similarly, battery cells housed in receptacles of a lower tray are restrained in a second direction that is perpendicular to the plane of the lower tray where the second direction opposes the first direction. Receptacles in the lower tray may also be designed to restrain battery cells in directions that are within the plane of the lower tray. Additionally, both trays may include features that substantially restrain battery cells in rotational motion. Thus, a battery module having upper and lower trays may serve to restrain motion in 3 rotational directions and 3 translational directions of battery cells that are held between the trays.

In another aspect, battery assemblies may include the ability to monitor the temperature of one or more battery cells or regions in the assembly. As described herein, the ability to monitor the temperature of a battery cell or a region in the assembly may include monitoring the temperature of a space adjacent to a battery cell and/or monitoring the temperature of a portion of a battery cell. In one embodiment, a battery assembly includes a cell tray where a thermal sensor is positioned in a receiving portion of the cell tray such that the thermal sensor is disposed adjacent to a battery cell. In another embodiment, the thermal sensor positioned in the receiving portion is in contact with a battery cell.

In a further aspect, battery assemblies may also include a plurality of straps that are used to secure a plurality of battery cells together. In an embodiment, a tightly tensioned strap is wrapped around a plurality of battery cells that are disposed in receptacles of a battery cell tray such that the battery cells are firmly fixed relative to one another. In another embodiment, a loosely tensioned strap is wrapped around a plurality of battery cells that are disposed in receptacles of a cell tray for a user to conveniently carry the plurality of cells together. In some cases, straps that are both tightly tensioned and loosely tensioned are used to firmly secure a cluster of battery cells together while providing a user with the ability to carry the cluster of battery cells together with relative ease. In some embodiments, loosely tensioned straps are positioned symmetrically with respect to one another so that a cluster of battery cells can be balanced when carried. In more embodiments, cell trays have guide features that serve to securely position tensioned straps such that slippage of the straps is minimized.

In yet another aspect, the receiving area of a battery cell tray is adjustable in configuration. The receiving area of a cell tray may have a first configuration of receptacles for receiving an arrangement of battery cells. The cell tray may be modified from a first configuration of receptacles to a second configuration of receptacles that is adapted to receive a different arrangement of battery cells. In various embodiments, receiving areas of cell trays are adjustable to decrease the number of regions (e.g., receptacles) that are adapted to receive battery cells. In other embodiments, receiving areas of cell trays are adjustable to increase the number of regions (e.g., receptacles) that are adapted to receive battery cells.

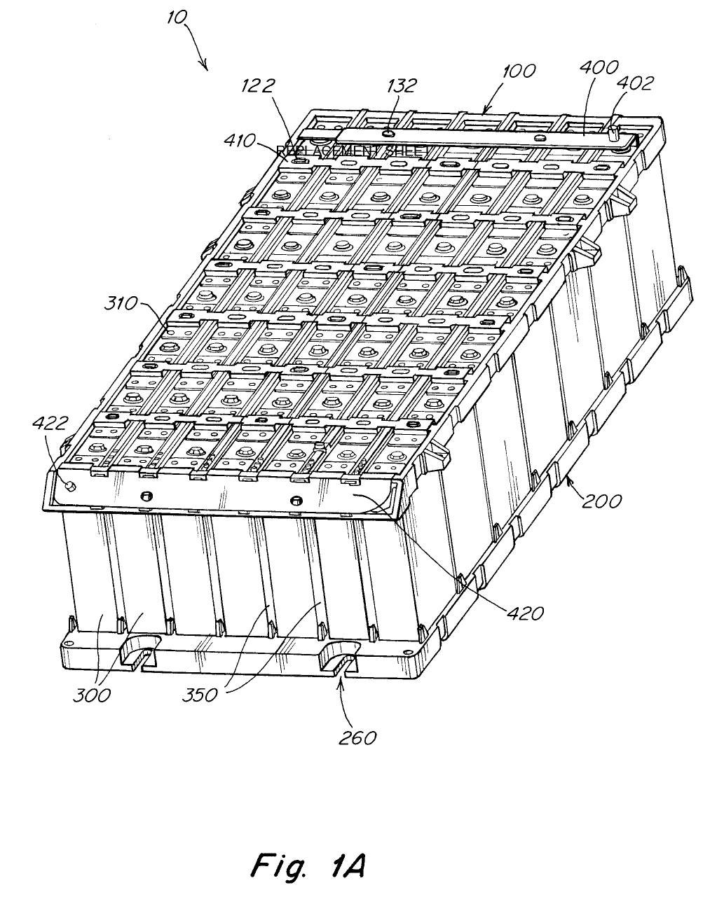

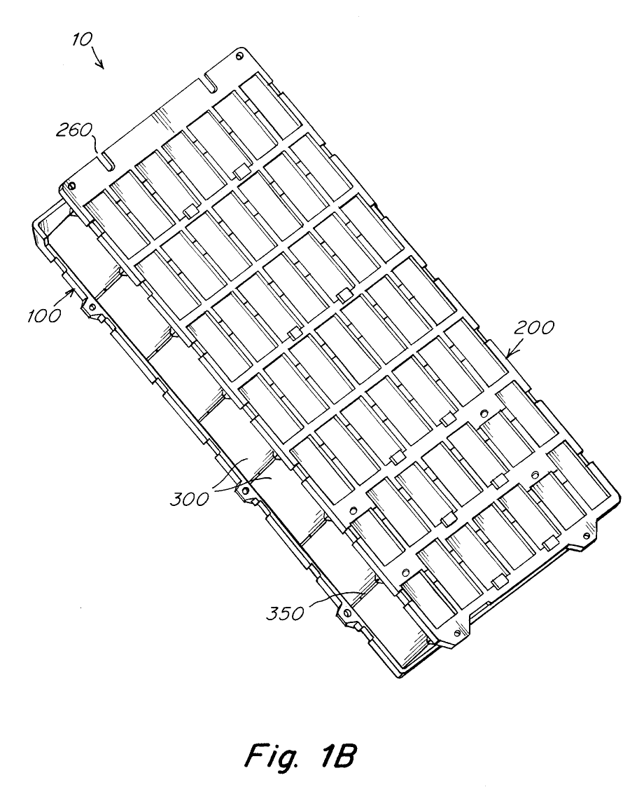

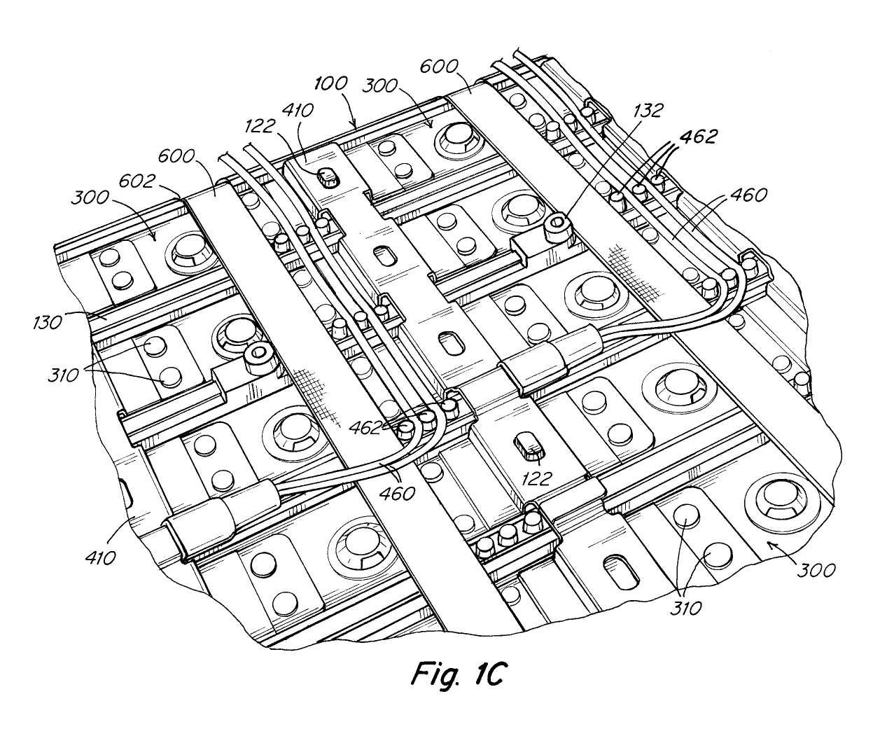

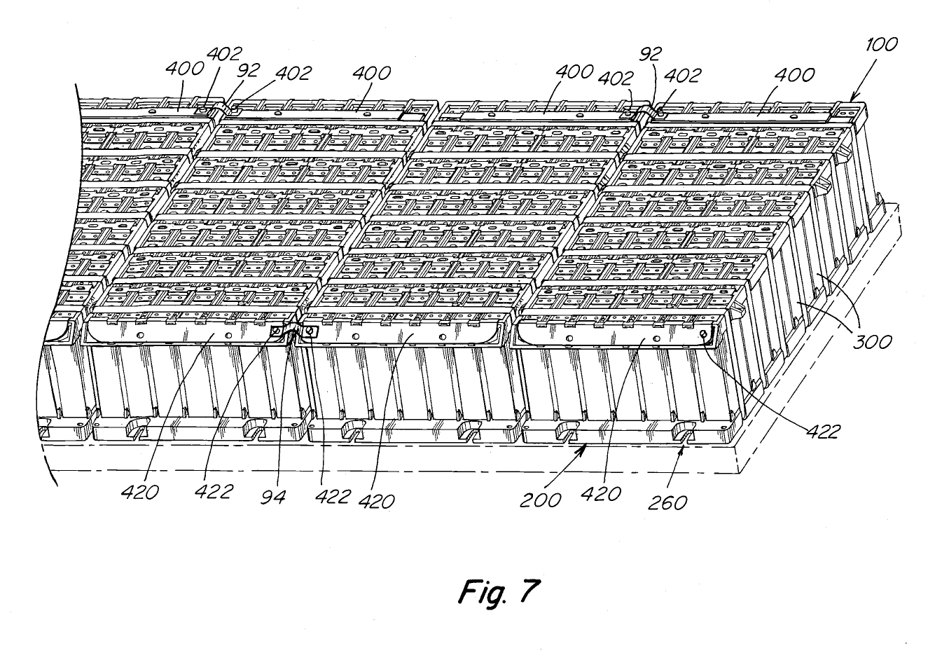

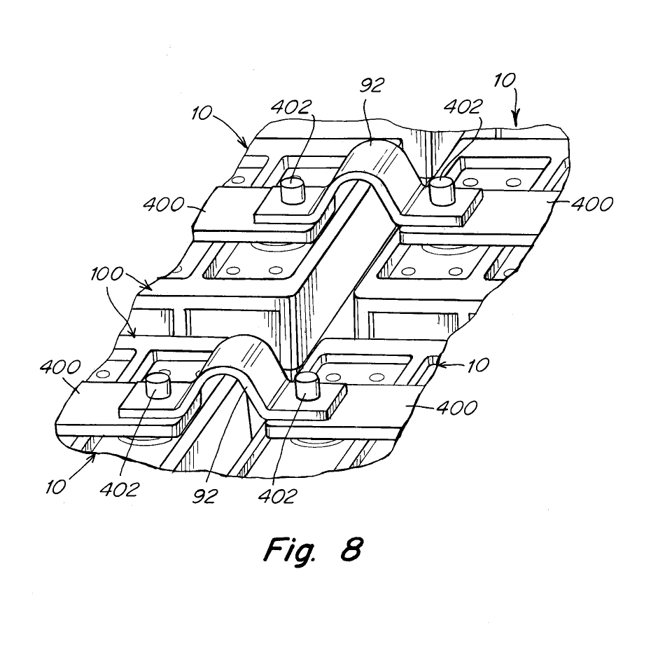

Turning to the figures, FIGS. 1A and 1B depict top and bottom perspective views of an illustrative embodiment of a battery assembly 10. Battery assembly 10 includes an upper tray 100, a lower tray 200 and a plurality of battery cells 300 that are held between upper and lower trays 100 and 200. Battery cells 300 may be any suitable shape, for example, prismatic. FIGS. 1A and 1B depict trays 100 and 200 having receptacles that allow for 49 battery cells to be arranged in a 7×7 grid-like assembly. However, it can be appreciated that cell trays may be configured to accommodate any suitable number and arrangement of battery cells. In addition, it can be appreciated that battery assemblies may also include more than one pair of cell trays. For example, a battery assembly may include cell trays that are attached to one another in a side-by-side relation by appropriate connection elements, as described further below in FIGS. 7 and 8.

Battery cells 300 each have terminals 310. Terminals 310 includes a positive battery terminal and a negative battery terminal.

Battery cells 300 disposed in cell trays may be spaced from one another by openings 350 provided by construction of the receptacles in the trays. In some embodiments, openings 350 may provide space permitting air to flow between battery cells 300. Such air flow between battery cells may result in battery cells disposed in the receptacles to be suitably cooled, such as, while the cells are in use. For example, a cooling device such as a fan may be adapted to blow cooling air into channels created by openings 350 between battery cells. In an embodiment, the presence of openings 350 between battery cells 300 may also mitigate thermal conduction that would otherwise occur between battery cells if they were disposed in closer proximity to one another. Further, openings 350 may also provide space for thermal sensors to be positioned adjacent to or in contact with battery cells 300.

As discussed above, conventional arrangements of battery cells include cells that are bundled together where walls of battery cells are in contact with one another. Bundling of cells may serve to mitigate cell swelling by compression, save volumetric space, and/or decrease the required number of contact terminals. However, battery assemblies described herein where cells are spaced apart from one another may afford a number of advantages. One advantage for cells to be spaced apart is that cooling may occur between each individual cell. Another advantage for cells to be spaced apart is to minimize risk in the event of an undesirable occurrence. For example, if one battery cell experiences a mechanical load that gives rise to a fracture site, having battery cells spaced from one another may reduce the risk that the mechanical load and/or fracture may propagate to other cells.

FIG. 1A also illustrates busbars 400, 410 and 420 that are positioned alongside upper tray 100. In various embodiments, busbars may provide an electrical connection between battery cells and portions of the vehicle that derive power from the battery assembly. In an embodiment, busbar 400 provides for an electrical connection between battery cells disposed at an edge of the upper tray 100. Busbar 420 may provide an electrical connection between battery cells disposed at an edge of the upper tray 100 opposite to that of busbar 400. Busbars 410 may electrically connect battery cells that are disposed between busbars 400 and 420. In some embodiments, busbar 420 collects current that runs through other busbars, such as for example, the current of busbars 400 and 410. In such a case, added mechanical support is provided for busbar 420 to be adequately restrained.

In some cases, busbars are mechanically connected to regions of a cell tray. In an embodiment, features on the upper tray 100 of FIG. 1A provide for snap-in and/or screw-down attachment of busbars. For example, busbar 400 may include a connection post 402 that allows for a connection to be established with a neighboring busbar of a different cell tray. Upper tray 100 may also include an attachment portion 132 that functions to receive a complementary portion of busbar 400 so that the busbar can be attached to the tray. Busbars and other interconnection elements (e.g., metal interconnects) may be fastened to battery cells through any suitable method such as, for example, laser welding, resistance welding, ultrasonic welding, brazing, and/or mechanical fastening.

Busbar 420 is disposed at an edge of the upper tray 100 opposite to busbar 400 and also provides an electrical connection between battery cells. Like busbar 400, busbar 420 includes a connection post 422 that provides for a further connection to be made between busbar 420 and a neighboring busbar of a different cell tray. Busbars 410 run parallel to and are located between busbars 400 and 420. Each busbar 410 provides connections between battery cells that are disposed along a row of a corresponding busbar, as shown in FIG. 1A. Upper tray 100 may also include an attachment portion 122 that functions to receive a complementary portion of a busbar 410 so that the busbar can be appropriately attached to the tray. In an embodiment, a busbar provides a series electrical connection between battery cells that are disposed on either side of the busbar. Busbars may also provide a parallel electrical connection between battery cells that correspond to respective busbars.

Busbar 420 functions as a current collector interconnect where current originating from a number of rows of battery cells is transferred through the busbar. Due to increased amounts of current travelling through the busbar, restraining features may be provided (not shown) for limiting movement of the busbar. For example, busbar 420 may be attached to one or more boss features. Or, busbar 420 may be screwed and/or snapped into a restraining feature in order to prevent the busbar from substantial vertical movement.

In addition to connection posts that provide a method for busbars of neighboring cell trays to be connected, for some embodiments, additional mechanical features such as clips and/or posts may be included. In some cases, such mechanical features may allow for direct attachment of wiring harness elements (not shown in FIG. 1A). These harness elements may serve, for example, to prevent unrestrained wire motion by securing wires. Wires may be secured so as to permit consistent positioning of the wires upon vibration.

So that interconnection elements, busbars, or wiring harness elements are further protected, battery assemblies may include standoff features (not shown in the figures) that serve to provide added mechanical support to battery cells and to prevent a container of the battery assembly from damaging any of the above elements.

Busbars may have any suitable thickness or width. In some embodiments, busbars have a thickness of between about 0.1 mm and about 5 mm. In some embodiments, busbars have a width of between about 2 mm and about 40 mm.

Busbars may include any appropriate conductive material. In some embodiments, busbars include a strip of copper, aluminum, nickel or other suitable electrical conductor. In an embodiment, a copper busbar is Ni-plated. Indeed, busbars may include metallic and/or non-metallic conductors.

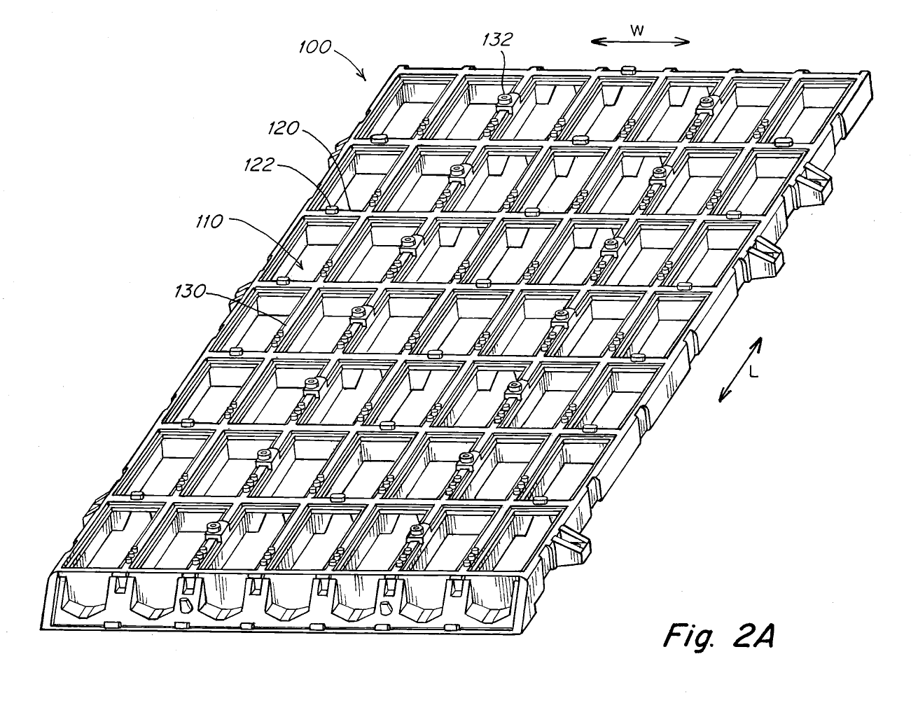

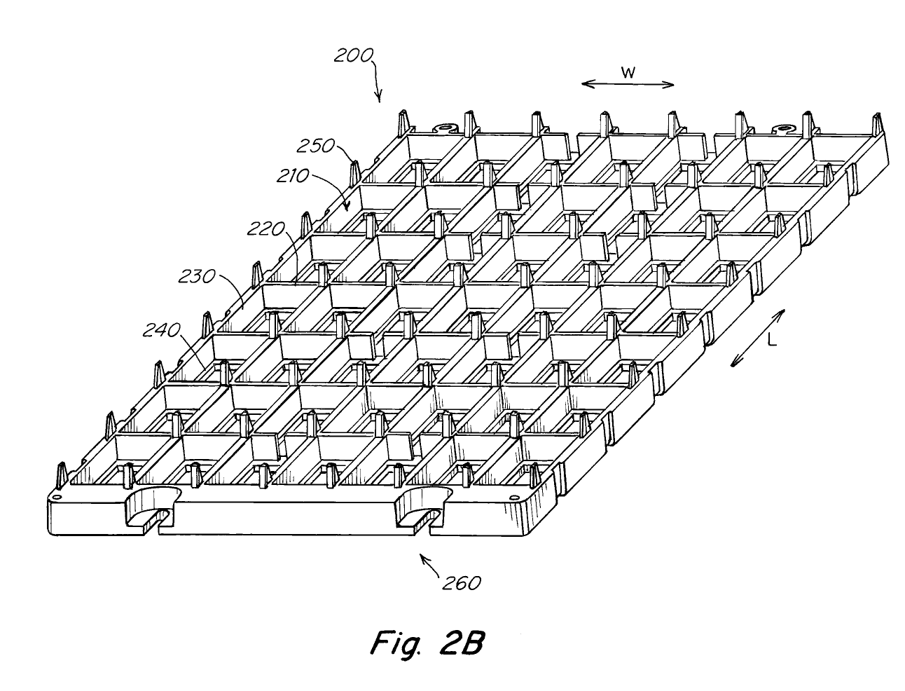

As discussed above, a battery assembly may have a number of components. FIG. 1C shows a close up view of a row of battery cells that are disposed in receptacles of an upper cell tray 100 and are also held by two tightly tensioned straps 600. The receptacles of the cell tray 100 are defined by upper struts 120 and 130 that are perpendicular to one another so as to give rise to a grid configuration. In FIG. 1C, upper struts 120 are covered from view by straps 600, but are shown in FIG. 2A. Posts 122 are disposed along upper struts 120 for busbars 410 to be attached to upper tray.

Straps 600 are assisted into position by guide features 602 that serve to better secure the straps 600 in place. Straps 600 that are secured in guide features 602 are less prone to slippage and provide the ability for battery assemblies to be handled in a relatively easier way as compared to if the guide features were absent. Different types of straps for use with the battery assembly will be discussed further below.

FIG. 1C also depicts a busbar 410 that extends across a top surface of a row of battery cells having terminals 310. The busbar 410 is welded to the battery cells as an interconnection element where cells on either side of the busbar are electrically connected in series. Busbar 410 is also positioned slightly above the surface of the cell tray so as to provide protection for the battery cell terminals. That is, a busbar interconnect that is positioned along the top surface of a battery cell may experience movement caused by external stresses. Such movement could lead to undesirable contact with other structural elements of the battery.

Further depicted in FIG. 1C are wires 460 that are electrically connected to the busbar 410 so that current and/or voltage signals can be conducted from the battery cells to or from the battery management system. Wires 460 are secured by wiring harness elements 462 that function to hold down and/or keep the wires in place when exposed to vibration or other external forces.

FIG. 2A depicts an illustrative embodiment of an upper cell tray 100 of a battery assembly. The upper tray 100 includes a plurality of receptacles 110 for receiving battery cells and defined by upper struts 120 and 130 in a grid configuration. In the embodiment depicted, upper struts 120 run parallel to reference direction W and are adapted to support busbars (shown in FIGS. 1A and 1C but not in FIG. 2A) that extend across upper tray 100 along the length of upper struts 120. In addition, posts 122 are disposed along upper struts 120 for busbars to be attached to upper tray 100 (depicted in FIGS. 1A and 1C).

Upper struts 120 provide spacing between battery cells that are disposed in a column along reference direction L. Upper struts 130, on the other hand, run parallel to reference direction L and provide spacing between battery cells that are disposed in a row along reference direction W. As discussed above, spacing between battery cells may allow for cooling air to flow between cells. Such spacing may also provide a region for thermal sensors to be disposed in close proximity to battery cells, as will be described later.

Upper struts 130 may include attachment sites 132 which provide the ability for other elements (e.g., wires, connectors, busbars) to be connected to the tray. Although not shown in FIG. 2A, for some embodiments, upper tray 100 includes a support feature (e.g., a ledge or beveled region) to provide added support for battery cells to be disposed in respective receptacles 110. In addition, although depicted in a grid configuration, it can be appreciated that upper tray 100 is not required to be arranged as a grid as other configurations are possible.

Another component of the battery assembly, as depicted in FIG. 2B, is lower tray 200. Lower tray 200 complements upper tray 100 and includes a plurality of receptacles 210 where battery cells may be received. Receptacles 210 are surrounded by lower struts 220 and 230 which run perpendicular to one another, giving rise to a grid configuration that matches the configuration of upper tray 100 in FIG. 2A. Thus, battery cells may be appropriately positioned in corresponding receptacles 110 and 210 of upper and lower trays. Lower struts 220 extend parallel to reference direction W and provide spacing between battery cells that are disposed in a column along reference direction L. Accordingly, lower struts 130 extend parallel to reference direction L and provide spacing between battery cells that are disposed in a row along reference direction W.

In some embodiments, receptacles 210 of lower tray 200 include support features 240 that provide support for battery cells to remain seated in the receptacles. In some embodiments, support features 240 include a ledge or a shelf portion on which battery cells may rest. In some embodiments, support features 240 include chamfers having radii on leading edges that may be able to facilitate placement of battery cells in receptacles 210. Thus, when a battery cell is disposed in a receptacle 210 and, hence, rests on a support feature 240, upon lifting of the lower tray 200, the battery cell is supported by the receptacle 210.

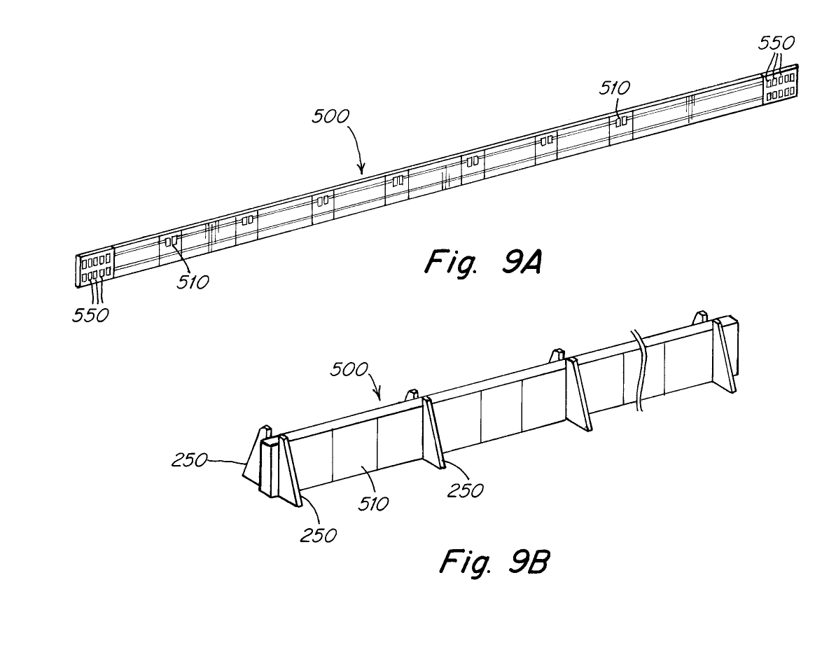

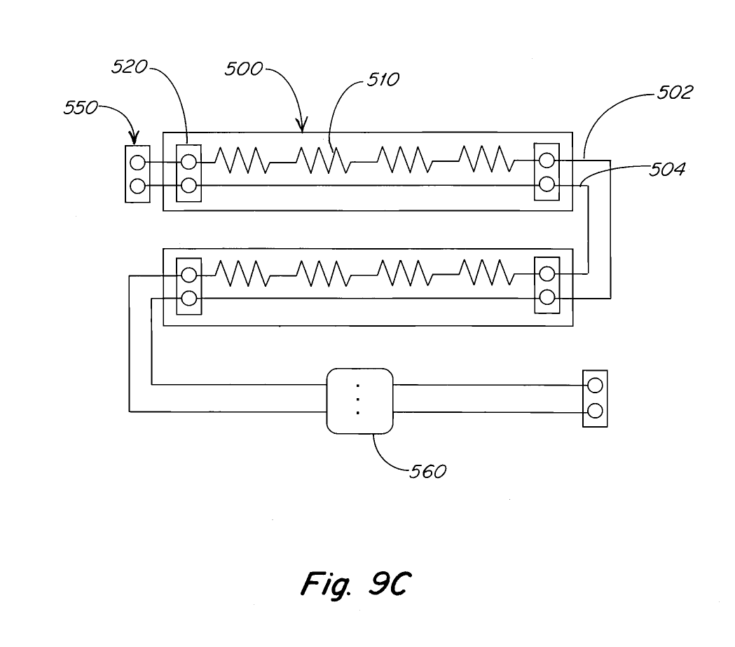

Lower tray 200 also includes positioning elements 250 that serve to support and position thermal sensors in close proximity to battery cells. Positioning elements 250 used to support thermal sensors will be described in more detail below in FIGS. 9A-9C.

Additionally, lower tray 200 includes an attachment region 260 for attaching the battery assembly to other components. For example, attachment region 260 may be used to attach one cell tray to another cell tray in a larger battery assembly. Alternatively, attachment region 260 may be used to attach a battery assembly to a support fixture of the battery enclosure.

In some embodiments, upper and lower trays are constructed differently from one another such as those depicted in FIGS. 2A and 2B. However, in other embodiments, upper and lower trays are similarly or identically constructed such that they may be interchangeable with one another.

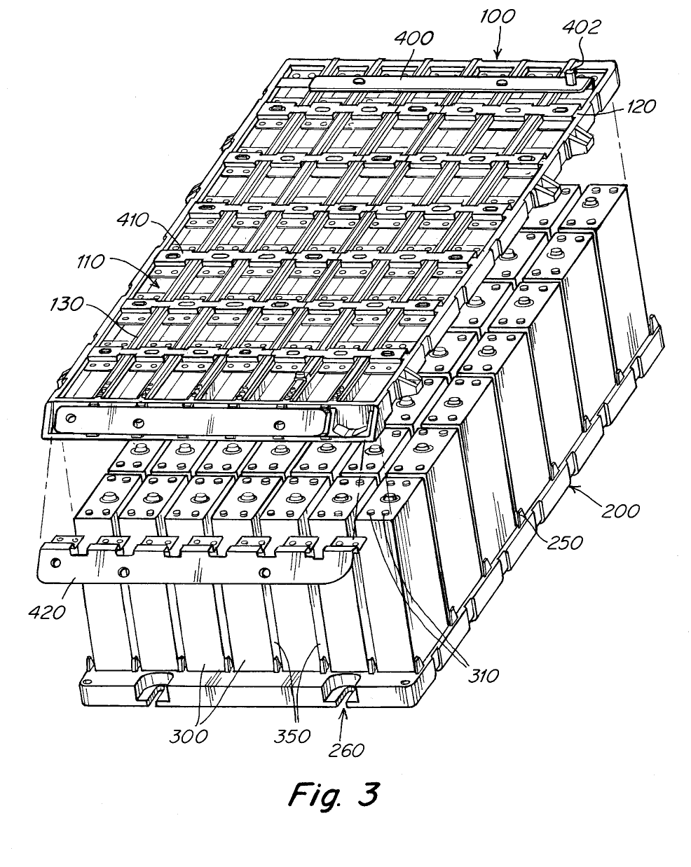

Continuing on, FIG. 3 illustrates a perspective view of components of the battery assembly 10 shown in FIGS. 1A-2B. Specifically, FIG. 3 depicts upper tray 100, busbars 400, 410 and 420, which are attached to upper tray 100, and lower tray 200.

Battery cells may be placed between upper and lower tray 100 and 200 by any appropriate method. In an embodiment, battery cells are placed in receptacles of a lower tray 200. Upper tray 100 is subsequently placed over corresponding battery cells such that receptacles of each tray face one another. Conversely, battery cells may be placed in receptacles of an upper tray 100, where a lower tray 200 with receptacles may subsequently be placed over corresponding battery cells. As discussed above, receptacles may also include support features (not explicitly shown the figures) that provide support for battery cells to remain secure.

Although not shown, locating fixtures may be provided between battery cells. In some embodiments, removable or permanent laths and/or battens are used to maintain positioning of battery cells. For example, upon installation of an upper tray on a group of battery cells that are disposed on a lower tray, locating fixtures may be inserted adjacent to one or more battery cells to occupy extra space so that the cells are more suitably or snugly positioned within receptacles.

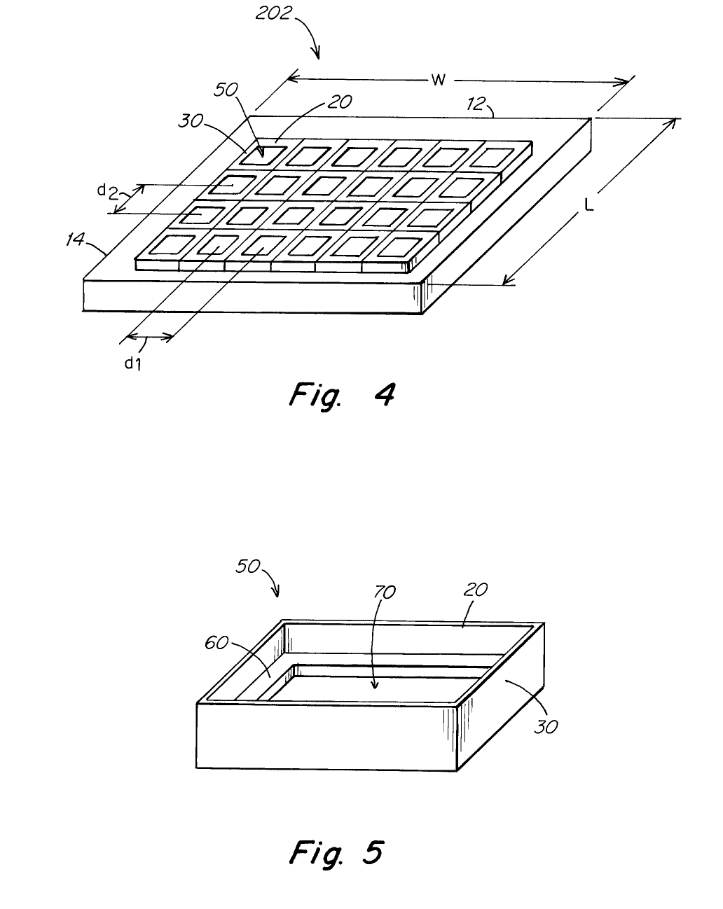

FIG. 4 depicts a schematic embodiment of a cell tray 202 of a battery assembly where the cell tray has sidewalls 12 and 14. As illustrated, sidewalls 12 run parallel to a reference direction W and sidewalls 14 run parallel to reference direction L. Within the sidewalls 12 and 14 are formed a plurality of receptacles 50 for housing battery cells. Each receptacle 50, in turn, has upstanding sidewalls 20 and 30.

Receptacles may be spaced apart from one another by an appropriate distance. In some embodiments, receptacles 50 are spaced apart from one another in the reference direction W by a center-to-center distance d₁. For example, d₁ may range between about 2 cm and about 30 cm. In other embodiments, receptacles 50 are spaced apart from one another in the reference direction L by a center-to-center distance d₂. For example, d₂ may range between about 2 cm and about 30 cm.

FIG. 5 illustrates a schematic of a receptacle 50 for receiving a battery cell. The receptacle includes sidewalls 20 and 30 and a bottom wall 60 which runs along the inside edge of the receptacle. In the embodiment depicted, the bottom wall 60 provides an opening 70 in the center of the receptacle. Upon placement of a battery cell in the receptacle 50, the battery cell resides against bottom wall 60 while being supported by sidewalls 20 and 30. Accordingly, battery cells may be suitably held within receptacles of a cell tray as the cells are restrained from substantial motion while residing in the receptacles. In one example, a single battery cell resides in a single receptacle. However, it may be possible for more than one battery cell to reside in a single receptacle, for example, a longer receptacle to house multiple battery cells.

Sidewalls 20 and 30 may be formed with appropriate dimensions. In an embodiment, sidewall 20 has a length of between about 1 cm and about 20 cm, a height of between about 1 cm and 10 cm, and a width of between about 1 cm and about 20 cm. In a further embodiment, sidewall 30 has a length of between about 1 cm and about 20 cm, a height of between about 1 cm and 10 cm, and a width of between about 1 cm and about 20 cm. In some embodiments, the bottom wall 60 extends inward a distance of between about 1 mm and about 5 cm, leaving an opening 70. In various embodiments, opening 70 has an area of between about 1 cm² and about 100 cm².

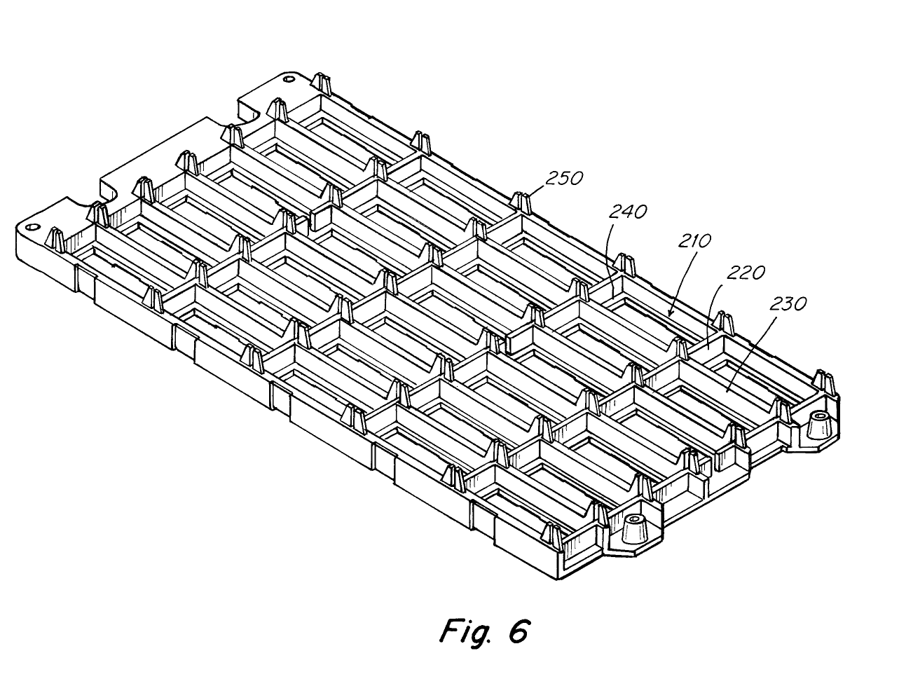

FIG. 6 depicts a different embodiment of a cell tray. As discussed above, it can be appreciated that a cell tray may have a configuration that provides for any suitable number and arrangement of battery cells. In the embodiment shown in FIG. 6, a cell tray includes a plurality of receptacles 210 for receiving battery cells. As depicted, receptacles 210 accommodate 30 battery cells that may be arranged in a 5×6 grid-like assembly.

Similarly to that described above for FIG. 2B, receptacles 210 in FIG. 6 are surrounded by struts 220 and 230 that are perpendicular to one another. In addition, struts 220 and 230, which are arranged in a grid configuration, may provide spacing between battery cells that are disposed in the receptacles 210. Further, support features 240 are also included so as to provide support for battery cells to be suitably disposed in receptacles 210. Positioning elements 250 are disposed at intersections of struts 220 and 230 and, as will be further discussed below in FIGS. 9A-9C, such positioning elements may be used to appropriately position thermal sensors in close proximity to battery cells.

Although embodiments provided illustrate lower trays to include positioning elements 250, but do not explicitly show upper trays to include positioning elements, it can be appreciated that any suitable positioning element may be incorporated in an upper tray. Accordingly, thermal sensors may be disposed in close proximity to battery cells via positioning elements on an upper tray.

Even further, despite embodiments having both an upper and a lower tray, it can also be appreciated that battery assemblies having both upper and lower trays are not required. Indeed, battery assemblies may include a single cell tray within which battery cells are disposed. For example, a single cell tray may include additional support features that provide attachment and/or harnessing elements that function to secure battery cells to appropriate regions of the cell tray.

It can be appreciated that battery assemblies may include one cell tray, a pair of cell trays or more than a pair of cell trays. In an embodiment, a battery assembly includes a plurality of cell trays disposed side by side to one another where each cell tray houses a number of battery cells. For example, a battery assembly may include a plurality of pairs of upper and lower cell trays where each of the pairs of upper and lower cell trays houses a number of battery cells. FIGS. 7 and 8 depict an illustrative embodiment of cell trays that are connected together at busbars 400 and 420 via connecting elements 92 and 94. Busbar 400 of cell tray 100 is connected by a connecting element 92 to an adjacent busbar of another cell tray. Similarly, busbar 420 of cell tray 100 is connected by a connecting element 94 to an adjacent busbar of another cell tray. As shown in FIG. 8, cell trays are attached together at busbar 400 via connecting element 92 that engages with connection post 402 of the busbar.

Connecting elements 92 and 94 are electrically conductive, providing a conductive pathway between busbars of neighboring battery assemblies. Accordingly, for example, an electrical current may travel along busbar 400 of cell tray 100 to a busbar of a neighboring cell tray through connecting element 92. Busbars that carry power from battery cells may also connect battery cells housed in different cell trays in a battery assembly. It should be understood that connecting elements may be arranged to connect busbars of cell trays together in any appropriate manner.

In another embodiment, a battery assembly includes a plurality of cell trays disposed in a stacked arrangement where battery cells restrained by a cell tray (or a pair of cell trays) are disposed above battery cells restrained by another cell tray (or another pair of cell trays). Similarly to how battery cells restrained by cell trays that are adjacent to one another may be connected through interconnection elements (e.g., busbars), battery cells housed in a stacked arrangement of cell trays may also be connected by appropriately positioned interconnection elements. Accordingly, the voltage and overall dimensions of battery assemblies can be selectively tailored based on the number of battery cells that are connected together as well as the relative position of battery cells with respect to one another. Indeed, a battery assembly may include a 3-dimensional array of battery cells with multiple battery cells disposed in 3 independent directions.

As indicated above, a battery assembly may include thermal sensors that are positioned adjacent to or in contact with battery cells so as to provide the ability for the temperature of battery cells to be monitored. In some embodiments, one or more thermal sensors are placed along a thermal sensing strip. The strip may be placed in a cell tray such that thermal sensor(s) on the strip are near to battery cells. For example, positioning elements that are located on an upper or lower tray may secure or support a thermal sensing strip so as to be positioned in between battery cells. In some embodiments, thermal sensors are individually placed in close proximity to battery cells without the support of a thermal sensing strip.

Any suitable device that can be used for monitoring temperature may be employed as a thermal sensor. In some embodiments, a thermal sensor is a positive temperature coefficient (PTC) resistive device or a thermistor element where, as temperature of the element increases above a characteristic temperature, the electrical resistance of the element also increases. A printed circuit board may be provided in conjunction with thermistor elements so as to measure changes in electrical resistance in addition to providing communication of thermal sensing to other systems of the vehicle.

FIG. 9A depicts an embodiment of a thermal sensing strip 500 having a plurality of thermal sensors 510 disposed along the strip 500. FIG. 9A illustrates 7 thermal sensors 510 that are disposed along the strip 500. Such a strip, for example, may be suitable for the lower tray 200 depicted in FIG. 2B, which is configured to store 7 battery cells along a row. However, it can be appreciated that any suitable number of thermal sensors may be provided on a thermal sensing strip.

In some embodiments, a thermal sensing strip 500 is flexible. Flexibility in a thermal sensing strip 500 may allow for the strip to be placed in a cell tray having one configuration and transferred to another cell tray having a different configuration or shape. Indeed, a thermal sensing strip that is flexible may be easily adjusted to suit varying configurations in cell trays.

However, in other embodiments, a thermal sensing strip 500 is substantially rigid. A substantially rigid thermal sensing strip 500 does not easily change shape and, thus, may be placed in a cell tray where significant mechanical adjustment is not required. In some instances, a thermal sensing strip that is substantially rigid provides convenience in assembly, where placement of thermal sensors in relation to adjacent battery cells is more predictably accomplished than if a more flexible strip were used. For example, the distance between thermal sensors and adjacent battery cells may be more consistent when thermal sensors are located along a more rigid thermal sensing strip as compared to a more flexible thermal sensing strip.

Indeed, in various embodiments, a thermal sensing strip 500 has enough flexibility so as to be adjustable upon placement in cell trays having different configurations, yet may also be rigid enough to maintain its position in a cell tray.

FIG. 9B shows a schematic of another illustrative embodiment of a thermal sensing strip 500 having thermal sensors 510 where positioning elements 250 are employed to appropriately support the strip. As discussed above, in some embodiments, positioning elements 250 are included in a cell tray and battery cells are disposed within receiving regions of the cell tray. In this embodiment, thermal sensing strip 500 is supported by positioning elements 250 such that thermal sensors are disposed in between battery cells (battery cells not shown in FIG. 9B). In an embodiment, positioning elements 250 lightly grip the thermal sensing strip 500 so that the strip remains relatively fixed in spaces adjacent to battery cells. For example, positioning elements 250 may provide a frictional fit to a thermal sensing strip 500. In another embodiment, positioning elements 250 provides a support structure for the thermal sensing strip 500 to reside without a frictional attachment. For example, the thermal sensing strip may be disposed adjacent to battery cells while leaning against supporting walls of positioning elements 250.

It can be appreciated that thermal sensors disposed between battery cells may be located by positioning elements 250 in upper cell trays and/or lower cell trays. In some cases, an upper and/or lower tray may include small holes so as to permit thermal sensors to be inserted between battery cells in regions that are commonly stagnant in airflow.

In some embodiments, thermal sensing strips are provided with a tightening mechanism and/or are installed with extra slack such that the strips can be easily tightened or loosened if adjustments are required after installation. For example, an improperly installed thermal sensing strip may result in thermal sensors not being positioned appropriately with respect to adjacent battery cells. Tightening/loosening mechanisms and/or extra slack in the thermal sensing strips may permit such adjustment to occur. In some embodiments, thermal sensing strips are placed within through-hole regions (not shown) of the cell tray to ensure appropriate positioning of the strips.

Further, thermal sensing strips may be attached to other thermal sensing strips that are disposed in positioning elements of a cell tray. In some cases, thermal sensing strips are easily inserted into and/or removed from a string of thermal sensing strips. Accordingly, in some embodiments, thermal sensing strips having malfunctioning thermal sensors are replaced with relative ease.

In some embodiments, thermal sensing strips 500 are connected together so that rows of battery cells may be concurrently monitored. For example, strips connected together in a series configuration may be monitored by a battery management system. In some cases, thermal sensing strips include a printed circuit board region that is in communication with a battery management system.

FIG. 9C illustrates a schematic embodiment of an assembly of thermal sensing strips where each thermal sensing strip 500 may include one or more thermal sensors 510 and printed circuit boards 520 within the strip. In some embodiments, printed circuit boards 520 function to send a signal to one or more terminals 550 once a thermal sensor 510 has detected a temperature above a certain threshold. Printed circuit boards 520 and/or terminals 550 may be in communication with a battery management system (not shown) which provides a feedback mechanism for when temperatures over a particular range are sensed.

In the assembly, a plurality of thermal sensing strips 500 may be configured and arranged so as to monitor the temperature of a cluster of one or more battery cells in a desired location of a cell tray. In one embodiment, thermal sensing strips 500 are connected to other thermal sensing strips via electrical connections 502 and 504. In an embodiment, thermal sensing strips 500 are connected in a series configuration. In some embodiments, thermal sensing strips 500 are provided in an assembly in a repeating pattern 560. However, it can be appreciated that an assembly of thermal sensing strips used to monitor temperature fluctuations of battery cells may be configured in any suitable manner. Indeed, it is not a requirement for thermal sensing strips to be attached or connected to other thermal sensing strips.

As discussed, thermal sensors or thermal sensing strips to which thermal sensors are attached may be connected to a battery management system. When the temperature of a battery cell or region increases past a certain threshold and, for some embodiments, a corresponding thermal sensor exhibits an increased electrical resistance, a signal is sent to the battery management system. Such a signal may indicate that the temperature of the battery cell or region has risen past a particular value so as to signify the occurrence of an over-temperature event for the battery cell or region.

Alternatively, a battery management system may receive a continuous signal indicative of the temperature of thermal sensors of a thermal sensing strip. Such a signal may be in the form of electrical resistance detection, for example. Once the battery management system detects the temperature of a battery cell or region increases past a particular threshold, the battery management system makes a determination that an over-temperature event has transpired.

As discussed, over-temperature events determined by a battery management system may be detected upon the increase of the temperature adjacent to a battery cell past a particular limit. In some embodiments, an over-temperature event is determined when the temperature adjacent to a battery cell rises over 70 C.

Once the battery management system determines that an over-temperature event has occurred within the battery assembly, a suitable feedback response, such as the triggering of a cooling device, may arise. In addition, depending on the degree of the over-temperature event, the battery management system may trigger an appropriate course of action (or inaction). For example, upon detection of one over-temperature event, a battery management system may activate a cooling system for the battery assembly, such as a fan or other cooling device. In another example, if the battery management system determines that the temperature exceeds a higher threshold, an emergency response may be triggered, such as safety shut down of vehicle components and battery disconnection. In a further example, a battery management system may determine that one or more battery cells are in need of replacement. In such a case, the battery management system may alert a vehicle operator through any suitable manner that replacement of one or more battery cells is required. In yet another example, if the battery management determines that the temperature has exceeded a certain amount, yet is not a cause for concern, a simple warning light may be activated. It can be appreciated that a number of different feedback responses may be elicited by the battery management system upon detection of an over-temperature event.

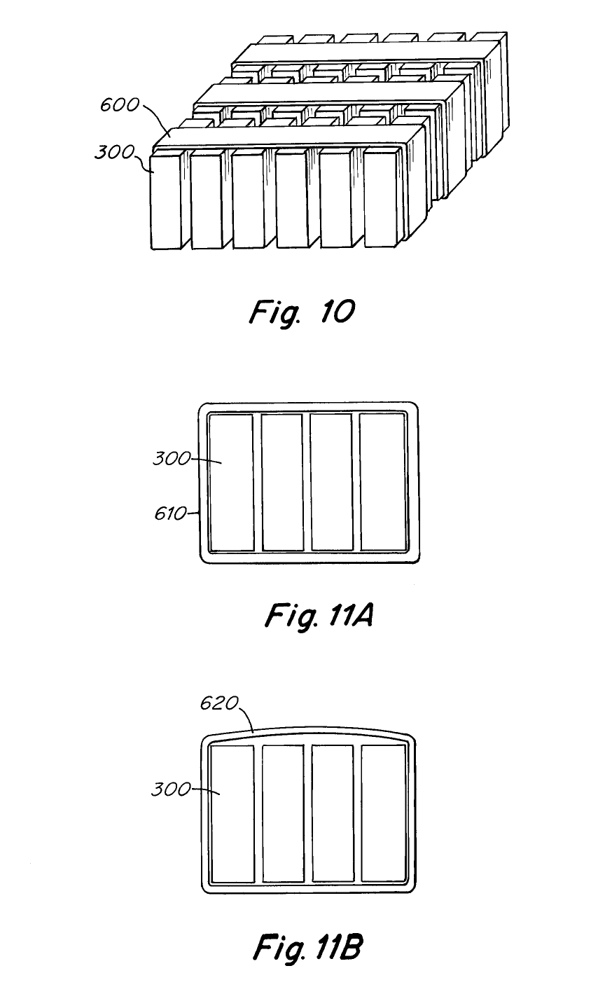

FIG. 10 shows a schematic of an embodiment of a plurality of battery cells 300 that are wrapped by tensioned straps 600 (cell trays are not shown). Any appropriate material may be used for straps 600 in holding battery cells 300 together and any method of installation may be employed. In an embodiment, plastic shipping strapping is installed to pack a row of battery cells together using a heat sealing operation.

FIG. 11A depicts an illustrative embodiment of a tightly tensioned strap 610 used to firmly secure a group of battery cells together. In some embodiments, tightly tensioned strap 610 has a tension of between about 50 lbs and 100 lbs. Accordingly, when battery cells are less prone to movement relative to one another, various assembly procedures may be more easily carried out such as by welding (e.g., laser, resistance, ultrasonic), brazing and/or fastening of cell interconnects to individual battery cells. In addition, battery cells held together by a tightly tensioned strap may be more easily transported as a group.

FIG. 11B shows an illustrative embodiment of a loosely tensioned strap 620 that provides the ability for a user to carry a group of battery cells together. In some embodiments, loosely tensioned strap 620 has a tension of less than about 50 lbs; or less than about 30 lbs when battery cells are carried together. In an embodiment, where loosely tensioned straps 620 are used by a user to carry a group of battery cells housed in a cell tray, a pair of loosely tensioned straps 620 are symmetrically located at opposite ends of a cluster of battery cells (e.g., 7×7 grid) to facilitate ease of movement of the battery cells. It can be understood that prior to the battery cells being carried, no tension is present in the strap 620. However, upon carrying of the battery cells, strap 620 becomes loosely tensioned.

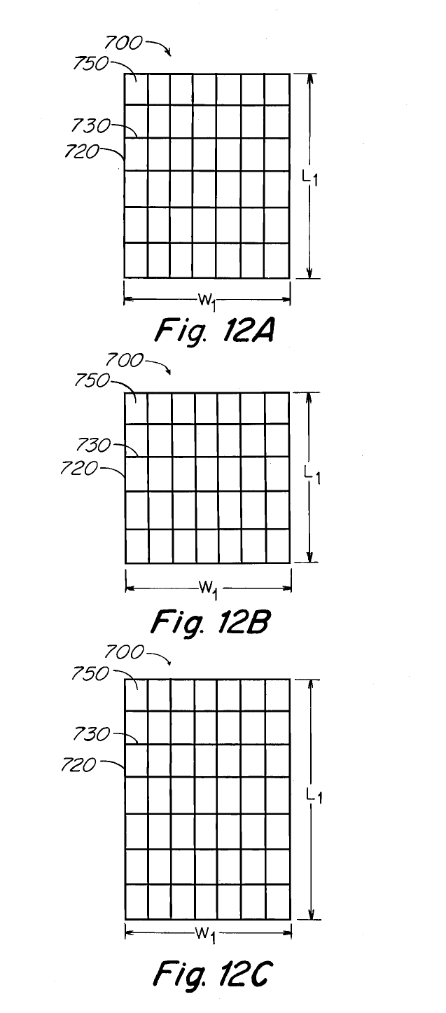

In a further aspect, configurations of receiving regions in cell trays may be adjustable. FIGS. 12A-12C depict schematic embodiments of cell trays having different configurations of receiving regions for battery cells. FIG. 12A illustrates an example of a cell tray 700 having struts 720 and 730 that give rise to a 7×6 grid configuration of 42 battery cell regions 750. In some embodiments, battery cell regions 750 are receptacles. As provided in FIGS. 12A-12C, the width of the cell tray 700 is provided by d₁ and the length is provided by d₂.

In some embodiments, the number of battery cell regions 750 or receptacles can be decreased. For example, the cell tray 700 of FIG. 12A may be modified to the configuration shown in FIG. 12B. As shown, the configuration of cell tray 700 has been adjusted to a 7×5 grid configuration of 35 battery cell regions 750. In addition, while the width W of the cell tray 700 remains the same, the length L₁ of the cell tray 700 has decreased.

In some embodiments, to change the configuration of a cell tray 700 from that shown in FIG. 12A to that shown in FIG. 12B, a row battery cell regions 750 is removed. In some cases, struts 720 and/or 730 may have mechanical detachment features that permit portions of the cell tray 700 to be removed. For example, struts 720 and/or 730 may be configured to have press-fit attachment/detachment mechanisms that allow for battery cell regions 750 to be added and/or removed. Press-fit mechanisms may include insertable features that give rise to a friction or interference fit between strut regions. In other cases, struts 720 and/or 730 may have brittle regions that allow for portions of the cell tray 700 to be broken off. For instance, a particular region of a strut may be more prone to breakage such that upon exertion of a sufficient pressure on the cell tray, struts will give rise to a clean fracture between battery cell regions 750. Any feature that gives rise to breakage may utilized. For example, struts may be manufactured to include score lines, perforations and/or may have material modifications at particular regions of the cell tray.

In more embodiments, a cell tray 700 is adjusted to increase the number of battery cell regions 750. As an example, the cell tray 700 of FIG. 12A may be modified to the configuration shown in FIG. 12C. As depicted, the configuration of cell tray 700 has been adjusted to a 7×7 grid configuration of 49 battery cell regions 750. While the width W of the cell tray 700 remains the same, the length L₁ of the cell tray 700 has increased.

In some embodiments, adjusting the configuration of a cell tray 700 from that shown in FIG. 12A to that shown in FIG. 12C involves adding a further row of battery cell regions 750. In some embodiments, as discussed above, struts 720 and/or 730 have attachment features that permit additional battery cell regions 750 to be added to the cell tray 700. Mechanical attachment features of struts 720 and/or 730 for battery cell regions 750 or receptacles to be suitably added may include press-fit or interference fit features for attachment or detachment of one strut to/from another strut.

In some embodiments, a cell tray may have a grid configuration. Where a cell tray is configured as a grid, the width W₁ of the cell tray may range between about 0.1 m and about 2 m; and the length L₁ of the cell tray may range between about 0.1 m and about 2 m. It can be appreciated, however, that a cell tray 700 may have any suitable configuration and is not required to be configured as a grid.

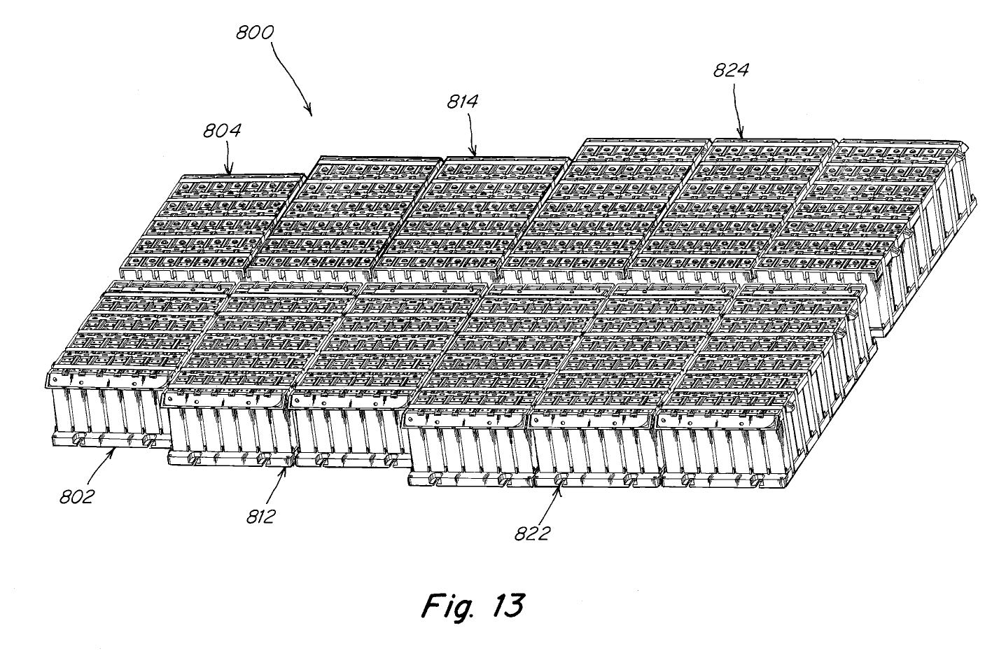

FIGS. 13-15 depict examples of battery assemblies and sub-assemblies described herein. FIG. 13 shows a battery assembly 800 having a plurality of battery cell sub-assemblies with each sub-assembly housing a plurality of battery cells. As shown, rows of battery cells in each sub-assembly are secured together by tightly tensioned straps. Battery cell sub-assemblies are also depicted to have varying configurations where the number of battery cells that are positioned in respective cell trays may vary according to the particular dimensions of the cell trays.

Battery assembly 800 of FIG. 13 includes a plurality of battery cells retained by 12 sub-assemblies. Each sub-assembly includes an upper cell tray, a lower cell tray, and a plurality of battery cells disposed in between the trays. As illustrated, sub-assemblies 802 and 804 are depicted opposite one another from a centerline and include receptacles for housing 5 rows of battery cells; oppositely positioned sub-assemblies 812 and 814 include receptacles that house 6 rows of battery cells; and sub-assemblies 822 and 824 positioned on either side of a centerline include receptacles for housing 7 rows of battery cells. It should be understood that any suitable number of cell trays and/or sub-assemblies may be included in a battery assembly. In an embodiment, 16 sub-assemblies are incorporated in a battery assembly.

In some embodiments, a battery assembly is positioned in a larger container or battery box for sub-assemblies of the battery assembly to be contained together in forming a larger battery assembly. As such, battery cells may be positioned within receptacles of upper and lower cell trays and spaced apart from one another according to how the receptacles are constructed. Battery cells disposed within receptacles of upper and lower cell trays, together with the cell trays, may be grouped into a sub-assembly. Sub-assemblies may be disposed adjacent to one another and may or may not be in a spaced apart relation.

A battery assembly may be referred to as a battery pack and a battery sub-assembly may be referred to as a battery module. That is, a battery module includes one or more battery cell trays where battery cells are disposed within receptacles of the tray(s). In an embodiment, a battery module includes an upper cell tray, a lower cell tray, and a plurality of battery cells disposed in receptacles of the upper and lower cell trays. In another embodiment, a battery module includes a single battery cell tray having receptacles that a plurality of battery cells are disposed within.

Thus, a battery pack may include a plurality of battery modules where each battery module includes battery cells that are spaced apart from one another due to their position within receptacles of cell trays of the module. Any suitable number of battery modules can be grouped together to form a battery pack. In some embodiments, a battery pack includes a container or battery box that is adapted to position battery modules within the container adjacent to one another. In some embodiments, battery modules of a battery pack are spaced apart from one another according to the structure of the container that respective battery modules are positioned within. In other embodiments, battery modules of a battery pack are clustered together in a container such that neighboring battery modules are in contact with one another, yet battery cells within the battery modules are in spaced apart relation.

Although a battery module and a battery sub-assembly may refer to the same grouping of battery cells disposed within receptacles of one or more cell trays, for some embodiments, a battery module may generally include one or more battery sub-assemblies within a battery assembly or a battery pack. That is, a battery module may also include a grouping of sub-assemblies where each sub-assembly includes upper and lower cell trays and a plurality of battery cells disposed within receptacles of the trays.

Cell trays of a battery assembly or sub-assembly may be fastened (e.g., bolted) to a larger battery container for the battery assembly. Any number of fasteners may be used to attach cell trays to a larger battery container. In one example, an upper tray includes 4 fasteners for attaching the tray to a battery container. In another example, a lower tray includes 2 fasteners for attaching the tray to a battery container. It can be appreciated that cell trays may be attached to a battery container by any suitable method.

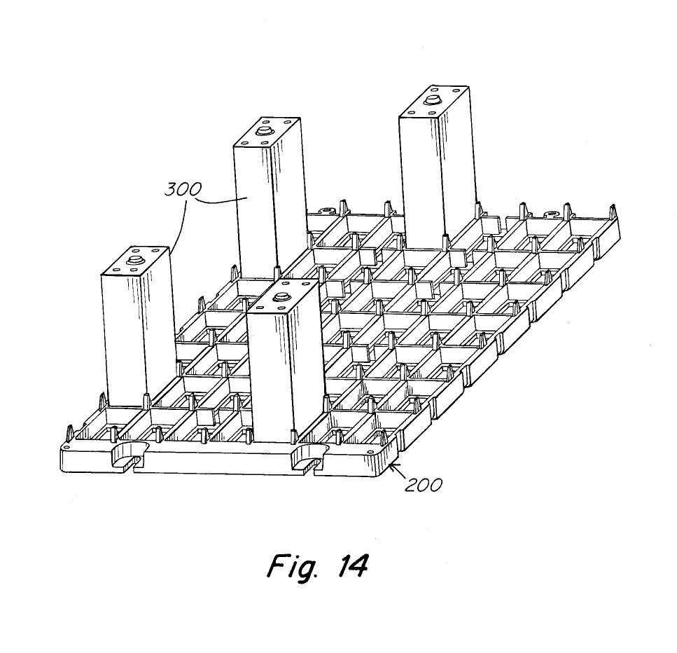

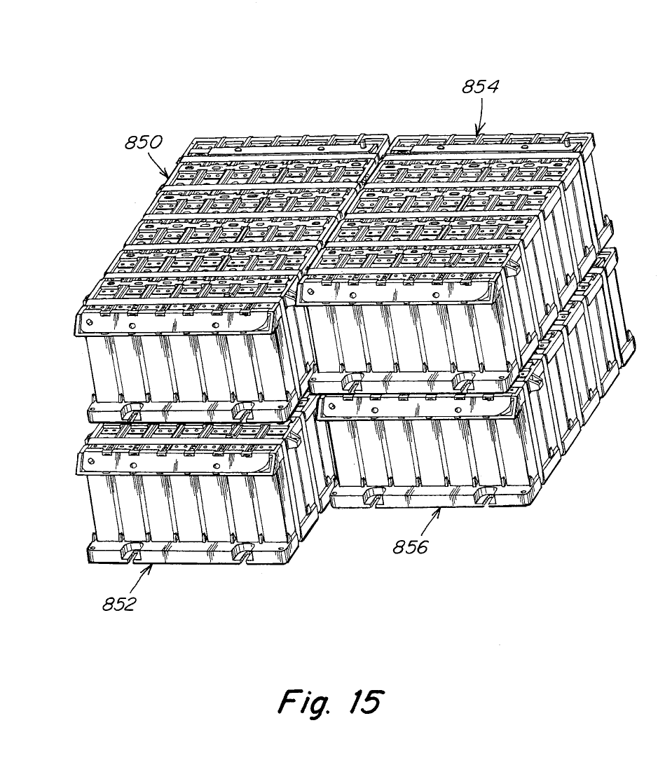

FIG. 14 depicts a plurality of cell trays 200 where battery cells 300 reside in receiving regions of various cell trays. In this embodiment, once cell trays 200 are filled with battery cells 300, corresponding upper trays (not shown in the figure) having busbars may be appropriately placed on top of the battery cells so as to form a battery assembly. Regions of the battery assembly, such as cell trays, may be firmly secured to other components in the vehicle, such as a container or a mechanical support feature.

FIG. 15 illustrates a battery module in an arrangement where one battery cell sub-assembly 850 is stacked on top of another battery cell sub-assembly 852. In this regard, battery cells in sub-assembly 850 are disposed above battery cells in another sub-assembly 852. Sub-assembly 850 includes receptacles for housing 6 rows of battery cells and sub-assembly 852 includes receptacles for housing 7 rows of battery cells. Sub-assemblies 854 and 856 include receptacles for housing 5 rows of battery cells. Battery cells 300 may be connected to one another across sub-assemblies through appropriate interconnection elements (e.g., busbars, wires). It can be appreciated that battery modules and assemblies may be tailored to suit desirable voltage characteristics and dimensions for the vehicle. For example, battery assemblies may include one or more sub-assemblies where battery cells are disposed in a 3-dimensional array and each sub-assembly is appropriately dimensioned to include any suitable number of battery cells.

U.S. Provisional Patent Application No. 61/363,470, filed Jul. 12, 2010, and entitled “Battery Assembly” is incorporated herein by reference in its entirety for all purposes.

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the foregoing description and drawings are by way of example only.

What is claimed is:

1. A battery module, comprising:
a first battery cell sub-assembly and a second battery cell sub-assembly, the first battery cell sub-assembly disposed adjacent to the second battery cell sub-assembly, wherein each of the first and second battery cell sub-assemblies comprises:
a lower battery cell tray having a plurality of lower receptacles;
an upper battery cell tray having a plurality of upper receptacles;
a plurality of battery cells that are restrained by the plurality of lower receptacles of the lower cell tray and the plurality of upper receptacles of the upper cell tray, wherein each cell is disposed in a corresponding receptacle and the plurality of battery cells are spaced from one another to allow for air flow between battery cells; and
a plurality of straps for securing the plurality of battery cells together in the plurality of lower and upper receptacles.

2. The battery module of claim 1, further comprising at least one interconnection element that is fastened to at least one battery cell of the plurality of battery cells.

3. The battery module of claim 2, further comprising at least one busbar that is attached to at least one attachment feature of the upper cell tray of one of the first or second battery cell sub-assemblies and connected to the at least one interconnection element.

4. (canceled)

5. The battery module of claim 1, further comprising wiring harness elements that are attached to attachment features of the upper battery cell tray of one of the first or second battery cell sub-assemblies.

6. The battery module of claim 1, further comprising at least one standoff feature on the upper battery cell tray or the lower battery cell tray of one of the first or second battery cell sub-assemblies for protecting an interconnection element or a wiring harness element.

7. The battery module of claim 1, wherein the first battery cell sub-assembly and the second battery cell sub-assembly are disposed in a stacked arrangement.

8. The battery module of claim 1, wherein the first battery cell sub-assembly and the second battery cell sub-assembly are disposed horizontally adjacent one another.

9. A battery module adapted to monitor temperature, comprising:
a plurality of battery cells;
an upper battery cell tray having a plurality of upper receptacles;
a lower battery cell tray having a plurality of lower receptacles, wherein each of the upper and lower receptacles are constructed and arranged to receive a single battery cell, the upper and lower battery cell trays including a plurality of receiving portions; and
at least one thermal sensor for sensing a temperature of a region near to at least one cell of the plurality of battery cells, wherein the at least one cell is disposed in at least one receptacle of the plurality of receptacles and the at least one thermal sensor is positioned by a region of the plurality of receiving portions such that the at least one thermal sensor is disposed adjacent to the at least one cell.

10. The battery module of claim 9, wherein the at least one cell disposed in the at least one receptacle is spaced from a different cell disposed in a different receptacle.

11. (canceled)

12. The battery module of claim 9, wherein the region of the plurality of receiving portions includes a temperature sensor positioning element.

13. The battery module of claim 12, wherein the temperature sensor positioning element is included in an upper battery cell tray or a lower battery cell tray.

14. The battery module of claim 12, wherein the at least one thermal sensor senses a temperature of a region that is in contact with the at least one cell of the plurality of battery cells.

15. (canceled)

16. The battery module of claim 9, wherein the at least one thermal sensor is mounted to a strip including a plurality of thermal sensors.

17-18. (canceled)

19. The battery module of claim 9, further comprising a battery management system adapted to detect an over-temperature event triggered by the at least one thermal sensor.

20. The battery module of claim 19, wherein the over-temperature event is triggered when the at least one thermal sensor exhibits a substantial increase in resistance.

21. The battery module of claim 9, wherein the at least one thermal sensor is positioned between a first battery cell and a second battery cell.

22. The battery module of claim 9, wherein the at least one thermal sensor is attached to the at least one cell.

23. A battery module, comprising:
a lower battery cell tray having a plurality of lower receptacles;
an upper battery cell tray having a plurality of upper receptacles;
a plurality of battery cells that are restrained by the plurality of lower receptacles of the lower cell tray and the plurality of upper receptacles of the upper cell tray, wherein each cell is disposed in a corresponding receptacle; and
a plurality of straps for securing the plurality of battery cells together, wherein the plurality of straps comprises at least one tightly tensioned strap adapted to firmly fix the plurality of battery cells together in the plurality of receptacles.

24. The battery module of claim 23, wherein the tightly tensioned strap has a tension ranging between about 30 lbs and about 100 lbs.

25. The battery module of claim 23, further comprising at least one loosely tensioned strap for facilitating carrying of the plurality of battery cells.

26-58. (canceled)
